(19) United States
(12) Patent Application Publication
(10) Pub. No.: US 2018/0243775 A1
(43) Pub. Date: Aug. 30, 2018

(54) HUB PAINT SPRAYING TRACELESS TRANSFER METHOD AND EQUIPMENT

(71) Applicant: CITIC Dicastal CO., LTD., Qinhuangdao (CN)

(72) Inventors: Zaide Wang, Qinhuangdao (CN); Zhiwei Qin, Qinhuangdao (CN); Hongtao Wang, Qinhuangdao (CN); Jinbao Su, Qinhuangdao (CN); Huanming Ma, Qinhuangdao (CN); Bo Ning, Qinhuangdao (CN); Zhiliang Zhang, Qinhuangdao (CN); Yongwang Zhao, Qinhuangdao (CN)

(21) Appl. No.: 15/627,912

(22) Filed: Jun. 20, 2017

(30) Foreign Application Priority Data
Feb. 25, 2017 (CN) 201710105132.4

(51) Int. Cl. B05B 13/02; B05B 15/12; B65G 47/90; B05D 1/38; B05D 7/24

(52) U.S. Cl. CPC B05B 13/02; B05B 15/12; B05D 7/24; B05D 1/38; B65G 47/90

(57) ABSTRACT

Disclosed are a hub paint spraying traceless transfer method and equipment Aiming at the problem of paint film damage in the existing wet-film paint sprayed hub transfer process, the transfer method and equipment are used for transferring a wet-film hub between a spraying ground chain and an oven ground chain, and a clamping jaw of a robot clamps a tray in the transfer process to complete transfer of the wet-film hub, so that damage of the paint surface due to direct contact is avoided and the overall quality of the hub product is improved.

### CROSS-REFERENCE TO RELATED APPLICATIONS

This application is filed based upon and claims priority to Chinese Patent Application No. 201710105132.4, filed on Feb. 25, 2017, the entire contents of which are incorporated herein by reference.

### TECHNICAL FIELD

The disclosure relates to a hub paint spraying traceless transfer method and hub paint spraying equipment for implementing the method, and belongs to the field of hub spraying technology.

### BACKGROUND

In the traditional spraying mode of an aluminum alloy hub, the hub is transferred from a hanging chain to a ground chain first, and the hub passes through a spraying operation room together with the ground chain and then enters an oven for baking. The ground chain is soaked into paint for long time in this spraying mode, leading to aggravation of chain blockage and oven dust. The existing spraying mode avoids the above two problems by adopting a spraying ground chain and an oven ground chain independent from each other, transferring the hub sprayed on the spraying ground chain to the oven ground chain and then feeding the hub into an oven. However, no matter in manual or mechanical transfer, the transfer operation leads to direct contact of the hub paint surface in a wet film state, and inevitably damages the hub paint surface; and with increasingly high requirement of customers for product quality, a new transfer method and equipment system are urgently needed to realize traceless transfer of a hub in a wet film state.

### SUMMARY

Aiming at the shortcomings of the above prior art, the disclosure provides a hub paint spraying traceless transfer method and equipment.

The technical solution for solving the technical problems adopted in the disclosure is that a hub paint spraying traceless transfer equipment includes a spraying ground chain, a carrying robot, a bracket, an oven ground chain, an oven, a paint spraying room, a first photoelectric probe, a second photoelectric probe, a tray and a support. The spraying ground chain and the oven ground chain are independent from each other, and the both are spaced an appropriate distance in a blank transfer area and located in the working range of the carrying robot; a hub bracket of the spraying ground chain and a hub bracket of the oven ground chain are sleeved on the support by the tray, the lower end of the support is installed on the ground chain, and a concave-convex structure matched with the tray is arranged at the upper end of the support to ensure synchronous rotation of the tray and the support when a hub is sprayed with paint. The tray is provided with a position for clamping. In the wet-film hub transfer area, both the spraying ground chain and the oven ground chain are provided with a robot action triggering device, and the robot action triggering devices are separately located in the support sweeping ranges of the spraying ground chain and the oven ground chain.

A hub paint spraying traceless transfer method includes the process flow of transferring a hub blank from a pretreatment hanging chain to a spraying ground chain tray, feeding the hub blank into a paint spraying room for spraying paint, feeding the web-film hub into a transfer area, transferring the web-film hub from an oven ground chain tray to an empty spraying ground chain bracket, transferring the web-film hub from a robot clamped spraying ground chain tray to an empty oven ground chain bracket, feeding the web-film hub into an oven for baking, cooling the hub sprayed product, and discharging the hub sprayed product.

Further, the carrying robot is equipped with a special clamping jaw, the opening and closing range of the clamping jaw is matched with the size of the clamping position of the tray, and the overall size of the clamping jaw is smaller than the size of the inner cavity of the hub.

Further, the action triggering devices are photoelectric probes.

Further, a closed hood is provided in the blank transfer area, and a viewing window is provided on the side of the closed hood.

The disclosure has the advantages: the transfer method and equipment are used for transferring the wet-film hub between the spraying ground chain and the oven ground chain, and the clamping jaw of the robot clamps the tray in the transfer process to complete transfer of the wet-film hub, so that damage of the paint surface due to direct contact is avoided and the overall quality of the hub product is improved.

### BRIEF DESCRIPTION OF THE DRAWINGS

FIG. 1 is a schematic plan of the disclosure.

FIG. 2 is a partial A enlarged view.

FIG. 3 is a section view of a bracket.

List of reference symbols:

1 spraying ground chain

2 blank line-transfer area

3 carrying robot

4 blank transfer area

5 bracket

501 first bracket

502 second bracket

503 third bracket

6 oven ground chain

7 product discharge area

8 oven

9 paint spraying room

10 first photoelectric probe

11 second photoelectric probe

12 tray

13 clamping position

14 support

### DETAILED DESCRIPTION

The disclosure will be further described in detail below in combination with embodiments and the accompanying drawings.

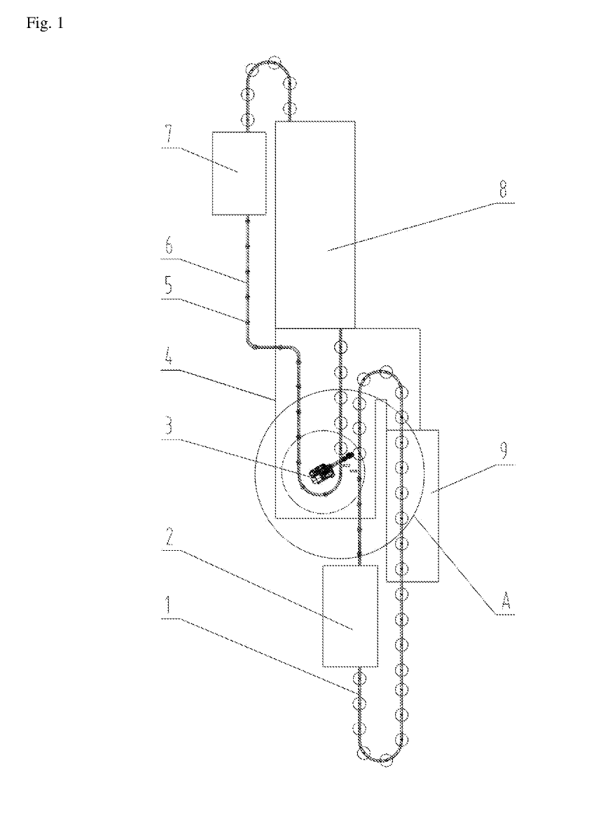

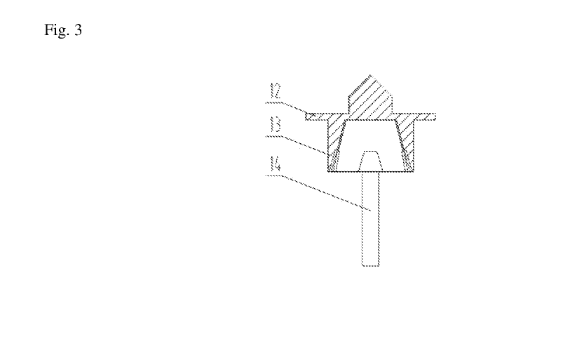

Hub paint spraying traceless transfer equipment includes a spraying ground chain 1, a carrying robot 3, a bracket 5, an oven ground chain 6, an oven 8, a paint spraying room 9, a first photoelectric probe 10, a second photoelectric probe 11, a tray 12 and a support 14. As shown in FIGS. 1, 2 and 3, the spraying ground chain 1 and the oven ground chain 6 are independent from each other, and the both are spaced a set distance in a blank transfer area 4 and located in the working range of the carrying robot 3. A first bracket 501 of the spraying ground chain 1 and a second bracket 502 of the oven ground chain 6 are sleeved on the support 14 by the tray 12, the lower end of the support 14 is installed on the ground chain, a concave-convex structure matched with the tray 12 is arranged at the upper end of the support 14, and the tray 12 is provided with a clamping position 13 for clamping; in the blank transfer area 4, the spraying ground chain 1 is provided with a second photoelectric probe 11, the oven ground chain 6 is provided with a first photoelectric probe 10, and the second photoelectric probe 11 and the first photoelectric probe 10 are separately located in the support sweeping ranges of the spraying ground chain 1 and the oven ground chain 6.

The carrying robot 3 is equipped with a special clamping jaw, the opening and closing range of the clamping jaw is matched with the size of the clamping position 13 of the tray 12, and the overall size of the clamping jaw is smaller than the size of the inner cavity of the hub.

A closed hood is provided in the blank transfer area 4, and a viewing window is provided on the side of the closed hood.

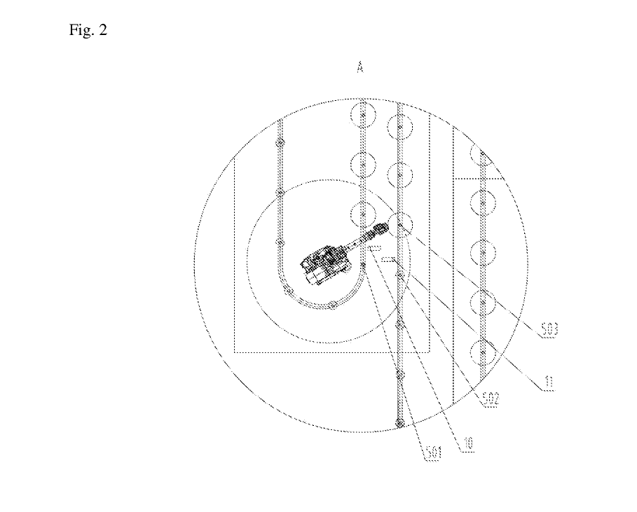

As shown in FIG. 2, a paint spraying traceless transfer method includes the steps of transferring a hub blank from a pretreatment hanging chain to the tray for the spraying ground chain 1, feeding the hub blank into the paint spraying room 9 for spraying paint, feeding the web-film hub into the transfer area 4, transferring the web-film hub from the tray for the oven ground chain bracket 501 to the empty spraying ground chain bracket 502, transferring the web-film hub from the tray for the robot clamped spraying ground chain bracket 503 to the empty oven ground chain bracket 501, feeding the web-film hub into the oven 8 for baking, cooling the hub sprayed product, and discharging the hub sprayed product.

What is claimed is:

1. A hub paint spraying traceless transfer equipment, comprising a spraying ground chain, a carrying robot, a bracket, an oven ground chain, an oven, a paint spraying room, a first photoelectric probe, a second photoelectric probe, a tray and a support, wherein the spraying ground chain and the oven ground chain are independent from each other, and the both are spaced a set distance in a blank transfer area and located in the working range of the carrying robot, a first bracket of the spraying ground chain and a second bracket of the oven ground chain being sleeved on the support by the tray, the lower end of the support being installed on the ground chain, a concave-convex structure matched with the tray being arranged at the upper end of the support, and the tray being provided with a clamping position for clamping; in the blank transfer area, the spraying ground chain being provided with a second photoelectric probe, the oven ground chain being provided with a first photoelectric probe, and the second photoelectric probe and the first photoelectric probe being separately located in the support sweeping ranges of the spraying ground chain and the oven ground chain.

2. The hub paint spraying traceless transfer equipment according to claim 1, wherein the carrying robot is equipped with a special clamping jaw, the opening and closing range of the clamping jaw is matched with the size of the clamping position of the tray, and the overall size of the clamping jaw is smaller than the size of the inner cavity of the hub.

3. A hub paint spraying traceless transfer method, comprising: transferring a hub blank from a pretreatment hanging chain to a spraying ground chain tray, feeding the hub blank into a paint spraying room for spraying paint, feeding the web-film hub into a transfer area, transferring the web-film hub from an oven ground chain tray to an empty spraying ground chain bracket, transferring the web-film hub from a robot clamped spraying ground chain tray to an empty oven ground chain bracket, feeding the web-film hub into an oven for baking, cooling the hub sprayed product, and discharging the hub sprayed product.
